(19) United States
(12) Patent Application Publication
(10) Pub. No.: US 2020/0365853 A1
(43) Pub. Date: Nov. 19, 2020

(54) POWER SUPPLY DEVICE, AND ELECTRIC VEHICLE AND POWER STORAGE DEVICE PROVIDED WITH SAID POWER SUPPLY DEVICE

(71) Applicant: SANYO Electric Co., Ltd., Daito-shi, Osaka (JP)

(72) Inventors: Hiroyuki Hashimoto, Hyogo (JP); Tomokazu Takashina, Hyogo (JP); Eri Kohira, Hyogo (JP)

(73) Assignee: SANYO Electric Co., Ltd., Daito-shi, Osaka (JP)

(21) Appl. No.: 16/966,566

(22) PCT Filed: Nov. 16, 2018
(86) PCT No.: PCT/JP2018/042372

§ 371 Date: Jul. 31, 2020

(30) Foreign Application Priority Data
Feb. 9, 2018 (JP) 2018-022519

(51) Int. Cl. H01M 2/10; H01M 10/625; H01M 10/658

(52) U.S. Cl. CPC H01M 2/1077; H01M 2/1083; H01M 2220/20; H01M 10/658; H01M 10/625

(57) ABSTRACT

A power supply device includes: a battery stack formed by stacking a plurality of battery cells; a separator disposed between the battery cells; and a fixing member for fastening the battery stack in a stacking direction. The separator includes an outer peripheral frame and a heat insulating base material member provided in an opening of the outer peripheral frame. The outer peripheral frame is disposed on an outer periphery of a stacking surface of the battery cell and has an opening inside, and the heat insulating base material member has flexibility of being deformed by being pressed by expanding of the stacking surface of the battery cell. The outer peripheral frame has higher rigidity than the heat insulating base material member, and specifies an interval between the adjacently stacked battery cells. The flexible heat insulating base material member absorbs expansion of the stacking surface of the battery cell.

### TECHNICAL FIELD

The present invention relates to a power supply device in which a plurality of battery cells is stacked. In particular, the present invention relates to a power supply device for a motor mounted on an electric vehicle such as a hybrid car, a fuel-cell car, an electric car, and an electric motorcycle to cause the vehicle to travel, to a power supply device for a large current used for a power storage application for a household and a factory, and to an electric vehicle and a power storage apparatus provided with the power supply device.

### BACKGROUND ART

A power supply device formed by stacking a plurality of battery cells has been adopted for various purposes. This type of power supply device preferably has a high capacity, and increase in capacity of the battery cell has been studied in recent years. In particular, an aim is to improve energy density per volume. As the capacity of the battery cell increases, an energy amount that each battery cell has increases. Therefore, a technique for preventing a chain of thermal runaways is more important.

In addition, it is generally known that an exterior can of the battery cell expands due to charge/discharge, deterioration, and during an abnormality such as a short circuit. When the energy density per volume increases, an expansion amount tends to increase. Therefore, when an assembled battery including a plurality of battery cells is configured, strength required for a restraint structure for preventing expansion of the battery cells increases. Therefore, a technique for reducing a load on the restraint structure of the assembled battery is demanded.

### CITATION LIST

### Patent Literature

PTL 1: Unexamined Japanese Patent Publication No. 2014-10983

### SUMMARY OF THE INVENTION

### Technical Problems

The present invention has been made to solve the above-mentioned conventional problems. An object of the present invention is to provide a technique capable of preventing a thermal runaway from being induced by blocking thermal conduction between battery cells, while absorbing expansion of the battery cells.

### Solution to Problems

A power supply device according to an aspect of the present invention includes: a battery stack formed by stacking a plurality of battery cells; a separator disposed between the battery cells; and a fixing member that fastens the battery stack in a stacking direction. The separator includes an outer peripheral frame and a heat insulating base material member provided in an opening of the outer peripheral frame. The outer peripheral frame is disposed on an outer periphery of a stacking surface of the battery cell and has the opening inside, and the heat insulating base material member has flexibility of being deformed by being pressed by the expanding stacking surface of the battery cell. The outer peripheral frame has higher rigidity than the heat insulating base material member, the outer peripheral frame specifies an interval between the adjacently stacked battery cells, and the heat insulating base material member having flexibility absorbs expansion of the stacking surface of the battery cell.

Further, an electric vehicle provided with the power supply device including the components of the above aspect includes: the power supply device; a traveling motor supplied with electric power from the power supply device; a vehicle body formed by mounting the power supply device and the motor; and wheels driven by the motor to cause the vehicle body to travel.

Further, a power storage apparatus provided with the power supply device including the components of the above aspect includes: the power supply device; and a power supply controller that controls charge and discharge to and from the power supply device, in which the power supply controller charges the prismatic battery cells with electric power from an outside and controls the battery cells to be charged.

### Advantageous Effect of Invention

The power supply device of the present invention can effectively prevent a thermal runaway from being induced by blocking thermal conduction between battery cells, while absorbing expansion of the battery cells. This is because, in the above power supply device, the separator stacked between the battery cells includes the outer peripheral frame and the heat insulating base material member, the outer peripheral frame is disposed on the outer periphery of the stacking surface of the battery cell and has the opening inside, the heat insulating base material member has flexibility of being deformed by being pressed by the expanding stacking surface of the battery cell, the outer peripheral frame has higher rigidity than the heat insulating base material member, the outer peripheral frame specifies the interval between the adjacently stacked battery cells, and the heat insulating base material member having flexibility absorbs expansion of the stacking surface of the battery cell.

In particular, in the power supply device of the present invention, the heat insulating base material member disposed in the opening of the outer peripheral frame is the base material deformed by the expansion of the battery cell, so that the heat insulating base material member can absorb expansion of the battery cell in close contact with the surface of the battery cell. In this structure, heat insulation can be performed without providing an air layer between the battery cell and the separator, and expansion of the battery cell can be absorbed by thickening the heat insulating base material member. Accordingly, while a heat insulating property is improved by the separator, it is possible to prevent various adverse effects caused by the expansion of the battery cell. The adverse effects are, for example, decrease in dimensional accuracy due to swelling of a battery block, deformation of end plates at both ends by being pressed with strong pressure, deformation of and damage to bind bars that couple the end plates at both ends caused by action of strong pulling force.

### BRIEF DESCRIPTION OF DRAWINGS

FIG. 1 is a perspective view of a power supply device according to one exemplary embodiment of the present invention.

FIG. 2 is an exploded perspective view of the power supply device of FIG. 1.

FIG. 3 is an exploded perspective view of a battery cell and a separator.

FIG. 4 is an exploded cross-sectional view showing a stacked structure of the battery cell and the separator.

FIG. 5 is an exploded perspective view showing an example of a heat insulating base material member.

FIG. 6 is an exploded cross-sectional view showing another example of the separator, and is a view showing a stacked structure of the battery cell and the separator.

FIG. 7 is an exploded cross-sectional view showing another example of the separator, and is a view showing a stacked structure of the battery cell and the separator.

FIG. 8 is a block diagram showing an example in which the power supply device is mounted on a hybrid car that runs with an engine and a motor.

FIG. 9 is a block diagram showing an example in which the power supply device is mounted on an electric car that runs only with a motor.

FIG. 10 is a block diagram showing an example in which the power supply device is used for a power storage apparatus.

### DESCRIPTION OF EMBODIMENT

First, one focus point of the present invention will be described. According to a power supply device disclosed in PTL 1, since a hole is provided in a center of a separator stacked between adjacent battery cells, the hole can absorb expansion of the battery cells. However, since a relatively large space is formed in the center of this separator, convection of air cannot be suppressed, and it is difficult to suppress heat conduction between the adjacent battery cells. Therefore, it is important to examine a structure that can absorb expansion of adjacent battery cells without providing a gap between the battery cells and that can prevent a thermal runaway from being induced by blocking thermal conduction between the battery cells.

A power supply device according to an aspect of the present invention may be specified by the following configuration. The power supply device includes battery stack 9 formed by stacking a plurality of battery cells 1, separator 2 disposed between battery cells 1, and fixing member 6 for fastening battery stack 9 in a stacking direction. Separator 2 includes outer peripheral frame 3 and heat insulating base material member 4 provided in opening 3X of this outer peripheral frame 3. Outer peripheral frame 3 is disposed on an outer periphery of stacking surface 1A of battery cell 1 and has opening 3X inside. Heat insulating base material member 4 has flexibility of being deformed by being pressed by expanding stacking surface 1A of battery cell 1. Outer peripheral frame 3 has higher rigidity than heat insulating base material member 4, outer peripheral frame 3 specifies an interval between adjacently stacked battery cells 1, and flexible heat insulating base material member 4 absorbs expansion of stacking surface 1A of battery cell 1.

Outer peripheral frame 3 is preferably made of plastic. Heat insulating base material member 4 may be composed of an insulating base material having innumerable voids and an insulating gel filled in the voids of this insulating base material. The insulating base material may be a fiber assembly base material in which flame-retardant fibers are three-dimensionally assembled in a non-directional manner and innumerable gaps are provided between the flame-retardant fibers. The insulating base material may be a foam having open cells. The insulating gel may be an aerogel. The aerogel is preferably silica aerogel. Outer peripheral frame 3 may have a frame shape along four sides of stacking surface 1A of battery cell 1.

An exemplary embodiment of the present invention is described below with reference to the drawings. However, the exemplary embodiment described below is an example for embodying the technical idea of the present invention, and the present invention is not limited to the following. Further, in the present description, members shown in the scope of claims are not limited to the members of the exemplary embodiment. Especially, it is not intended that the scope of the present invention be limited only to the sizes, materials, and shapes of components and relative arrangement between the components described in the exemplary embodiment unless otherwise specified. The sizes and the like are mere explanation examples. The sizes and the positional relation of the members in each drawing are sometimes exaggerated for clearing the explanation. Furthermore, in the following explanation, the same names or the same reference marks denote the same members or same-material members, and detailed description is appropriately omitted. Furthermore, regarding the elements constituting the present invention, a plurality of elements may be formed of the same member, and one member may serve as the plurality of elements. Conversely, the function of one member may be shared by the plurality of members.

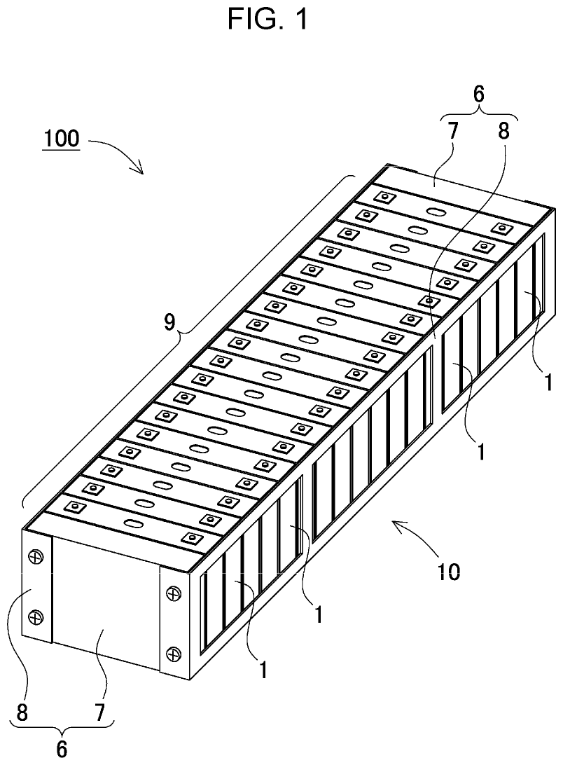

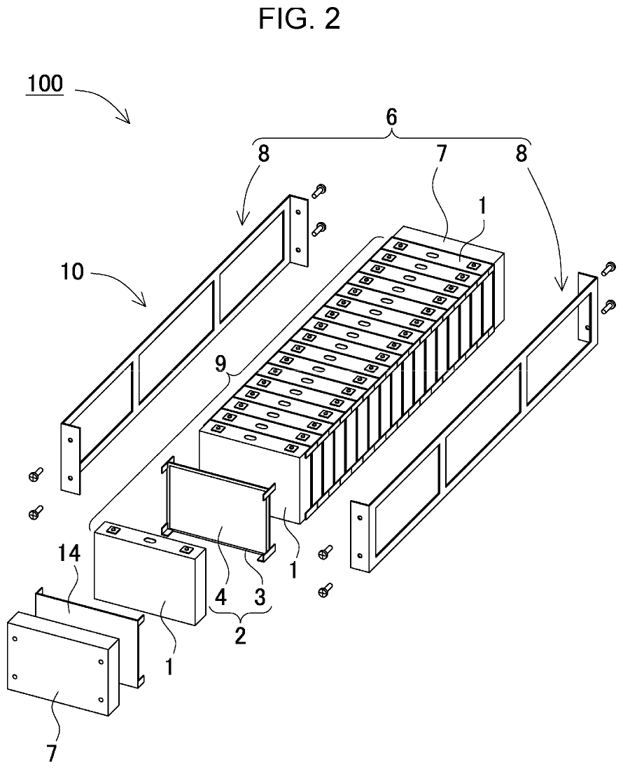

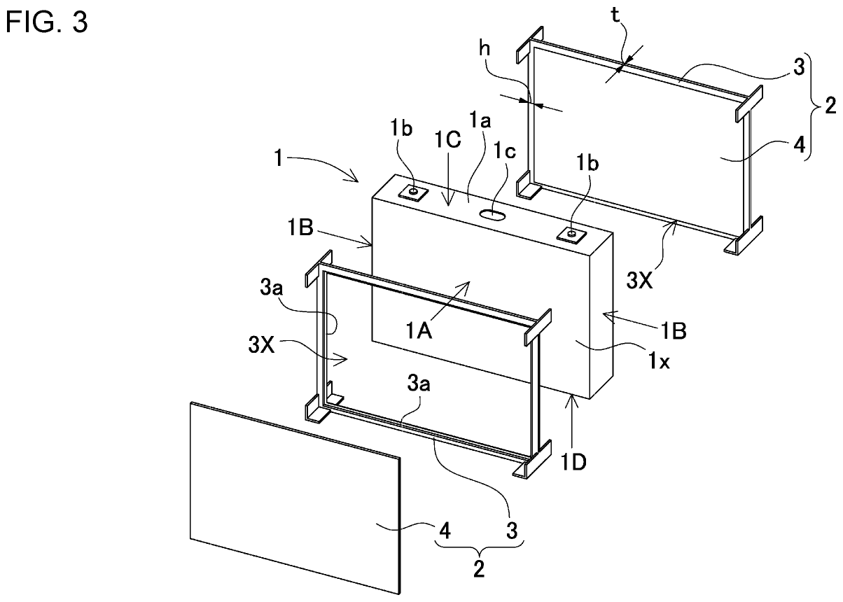

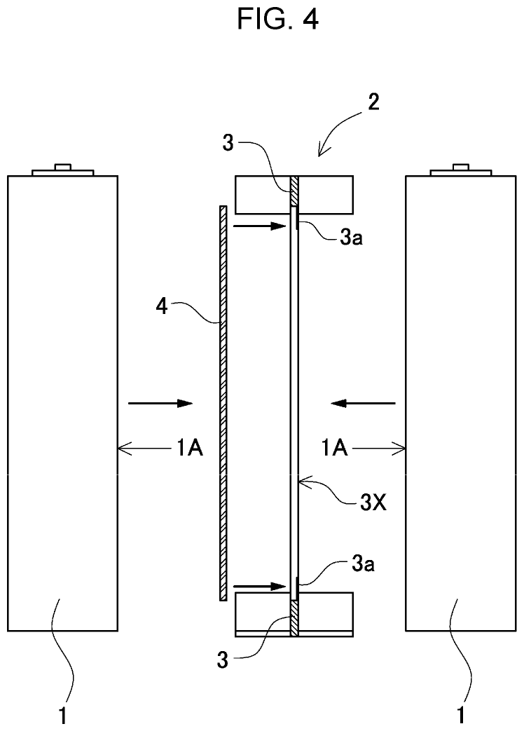

A power supply device according to the exemplary embodiment of the present invention is shown in FIGS. 1 to 4. In these drawings, FIG. 1 is a perspective view of the power supply device, FIG. 2 is an exploded perspective view of the power supply device of FIG. 1, FIG. 3 is an exploded perspective view of a battery cell and a separator, and FIG. 4 is an exploded cross-sectional view showing a stacked structure of the battery cell and the separator. This power supply device 100 is mainly mounted on an electric vehicle such as a hybrid car or an electric car, and is used as a power supply that causes the vehicle to travel by supplying electric power to a traveling motor of the vehicle. However, the power supply device of the present invention can be used for an electric vehicle other than the hybrid car and the electric car, and can also be used for an application requiring a large output other than the electric vehicle, for example, a power supply for a power storage apparatus.

Power supply device 100 shown in FIGS. 1 to 4 includes battery stack 9 formed by stacking a plurality of battery cells 1, insulating separator 2 disposed between battery cells 1, and fixing member 6 for fastening battery stack 9 in a stacking direction. In power supply device 100 shown in the drawings, battery stack 9 is fastened by fixing member 6 to form battery block 10.

### (Battery Cell 1)

As shown in FIG. 3, battery cell 1 has exterior can 1x, which forms an outer shape of battery cell 1, in a form of a prism having a width wider than a thickness, that is, having a thickness thinner than a width. Further, in battery cell 1, an opening of prismatic and bottomed exterior can 1x is closed by sealing plate 1a. Here, battery cell 1 in which an outer shape of exterior can 1x is prismatic includes bottom surface 1D which is a bottom side surface of bottomed exterior can 1x, stacking surfaces 1A which are facing surfaces of battery cells 1 stacked on each other and extend in a width direction, side surfaces 1B which are surfaces constituting both side surfaces of battery stack 9 and extend in a thickness direction of battery cell 1, and top surface 1C which is a surface configured by sealing plate 1a that closes the opening of exterior can 1x. The plurality of prismatic battery cells 1 is stacked in the thickness direction to form battery stack 9.

Note that in the present description, an up-down direction of battery cell 1 is a direction shown in the drawing, that is, the bottom side of exterior can 1x is a downward direction and sealing plate 1a side of exterior can 1x is an upward direction.

Battery cell 1 is a lithium ion battery. However, battery cell 1 can also be a rechargeable secondary battery such as a nickel hydrogen battery or a nickel cadmium battery. A power supply device in which a lithium ion secondary battery is used for battery cell 1 has a feature that a charging capacity with respect to volume and mass of the entire battery cell can be increased.

Further, battery cell 1 is provided with positive and negative electrode terminals 1b at both ends of sealing plate 1a that closes exterior can 1x, and is provided with safety valve 1c between a pair of electrode terminals 1b. Safety valve 1c can be opened to release internal gas when internal pressure of exterior can 1x rises to a predetermined value or more. This battery cell 1 can stop the internal pressure rise of exterior can 1x by opening safety valve 1c.

Here, the exterior can of battery cell 1 is made of metal. Therefore, in order to prevent the exterior cans of adjacent battery cells 1 from coming into contact with each other to cause a short circuit, insulating separator 2 is interposed between battery cells 1. In this way, the exterior can of battery cell 1 insulated by and stacked on separator 2 can be made of metal such as aluminum. Further, in order to prevent a short circuit due to dew condensation or the like, the exterior can may be covered with an insulating film or insulation-coated. In this case, insulation of the battery cell can be further enhanced and high reliability can be realized.

### (Separator 2)

Separator 2 is stacked between battery cells 1 to thermally insulate adjacent battery cells 1 from each other and also to keep a gap between stacked battery cells 1 constant. Separator 2 is stacked between adjacent battery cells 1 to insulate adjacent battery cells 1. This separator 2 is made of an insulating material. However, separator 2 stacked between battery cells 1 connected in parallel does not necessarily need to insulate adjacent battery cells 1, and can be a conductive separator. It is also possible to stack insulating separator 2 between battery cells 1 connected in parallel. The power supply device has a high output voltage by connecting all battery cells 1 in series. Alternatively, the power supply device has a high output current and a high output voltage by connecting the plurality of adjacent battery cells 1 in parallel and by connecting battery cells 1 connected in parallel in series.

Separator 2 includes outer peripheral frame 3 and heat insulating base material member 4, and heat insulating base material member 4 is disposed in opening 3X of outer peripheral frame 3. In this separator 2, outer peripheral frame 3 specifies an interval between adjacent battery cells 1, and heat insulating base material member 4 thermally insulates battery cells 1 to absorb expansion of battery cells 1. In outer peripheral frame 3, opening 3X can be made equal to an outer shape of heat insulating base material member 4, and opening 3X can be closed by heat insulating base material member 4. However, in outer peripheral frame 3, it is possible to make opening 3X slightly larger than the outer shape of heat insulating base material member 4 and to provide a slight gap outside heat insulating base material member 4. Alternatively, it is also possible to make opening 3X smaller than heat insulating base material member 4 and to dispose heat insulating base material member 4 on a surface.

### (Outer Peripheral Frame 3)

Outer peripheral frame 3 is disposed on an outer periphery of stacking surface 1A of battery cell 1, and has opening 3X inside. Outer peripheral frame 3 is made of hard plastic or ceramic having heat resistance and insulation. Outer peripheral frame 3 can be mass-produced at low cost with engineering plastic such as polycarbonate or polybutylene terephthalate (PBT) resin. However, outer peripheral frame 3 is made of resin having excellent heat resistance, for example, a thermoplastic resin such as polyphenylene sulfide (PPS), polypropylene, nylon, polyethylene terephthalate (PET), polyvinylidene chloride, or polyvinylidene fluoride, or thermosetting resin such as polyimide, fluororesin, polydiallyphthalate (PDAP), silicone resin, or epoxy resin. Outer peripheral frame 3 in FIG. 3 is formed in a frame shape along four sides of stacking surface 1A of battery cell 1 having the rectangular shape. Outer peripheral frame 3 is sandwiched between battery cells 1 to be stacked, and is formed of a rigid insulating material that specifies the interval between battery cells 1. In separator 2, heat insulating base material member 4 disposed inside outer peripheral frame 3 is deformed to absorb expansion of stacking surface 1A of battery cell 1, and outer peripheral frame 3 specifies the interval between battery cells 1. Therefore, outer peripheral frame 3 is made of an insulating material having higher rigidity than heat insulating base material member 4. Outer peripheral frame 3 having higher rigidity than heat insulating base material member 4 is sandwiched between battery cells 1 to make a dimension in the stacking direction of battery block 10 in which the plurality of battery cells 1 is stacked constant.

In battery block 10, battery cells 1 and separators 2 are stacked to form battery stack 9, end plates 7 are disposed on both end surfaces of battery stack 9, end plates 7 on both the end surfaces are coupled by bind bars 8, and battery cells 1 are stacked and fixed in a pressed state. Bind bars 8 are fixed to end plates 7 while pressing battery stack 9, and fixes battery cells 1 in the pressed state. Thickness (t) of outer peripheral frame 3, that is, the dimension in the stacking direction is, for example, 1 mm or more, preferably 2 mm or more, more preferably 2.5 mm or more so that heat insulating base material member 4 is deformed in a direction of being crushed and the expansion of stacking surface 1A of battery cell 1 can be absorbed. The dimension in the stacking direction of battery block 10 becomes large when outer peripheral frame 3 is thick. Therefore, thickness (t) of outer peripheral frame 3 is, for example, less than or equal to 5 mm, preferably less than or equal to 4.5 mm, optimally from about 3 mm to about 4 mm in consideration of the dimension of battery block 10.

Width (h) of outer peripheral frame 3 specifies a contact area with stacking surface 1A of battery cell 1, and the contact area specifies pressing force, that is, pressure of a unit area of stacking surface 1A of battery cell 1 stacked in a pressed state. If the pressure acting on stacking surface 1A is too large, it locally causes stacking surface 1A of battery cell 1 to be deformed by being pressed with strong pressure. Therefore, width (h) of outer peripheral frame 3 is, for example, 3 mm or more, preferably 4 mm or more, more preferably 5 mm or more in consideration of the contact area with stacking surface 1A of battery cell 1. If width (h) of outer peripheral frame 3 is too wide, the outer shape of heat insulating base material member 4 disposed in the opening 3X becomes small, and heat insulating base material member 4 has a small area for absorbing the deformation of stacking surface 1A. Therefore, width (h) of outer peripheral frame 3 ranges preferably from 5 mm to 30 mm inclusive, more preferably from 8 mm to 20 mm so that heat insulating base material member 4 can efficiently absorb the expansion of stacking surface 1A while preventing deformation due to the pressure of the stacking surface of battery cell 1.

### (Heat Insulating Base Material Member 4)

In addition to a heat insulating property, heat insulating base material member 4 is a base material having flexibility of being deformed by being pressed by stacking surface 1A of expanding battery cell 1. Heat insulating base material member 4 is pressed and deformed by expanding battery cell 1 to absorb the expansion of battery cell 1. In separator 2, flexible heat insulating base material member 4 absorbs the expansion of battery cell 1, and outer peripheral frame 3 which is not deformed by being pressed by battery cells 1 keeps an interval between battery cells 1 constant. Therefore, outer peripheral frame 3 has higher rigidity than heat insulating base material member 4, and outer peripheral frame 3 keeps a dimension between battery cells 1 constant. In separator 2, outer peripheral frame 3 realizes dimensional stability of battery block 10, and heat insulating base material member 4 absorbs the expansion of battery cell 1.

As heat insulating base material member 4, it is possible to use any base material having a heat insulating property of blocking heat energy of battery cell 1 that has been thermally runaway and having flexibility of being deformed by being pressed by expanding battery cell 1. In addition, flame-retardant and heat-resistant heat insulating base material member 4 can stably block thermal conduction of battery cell 1 in a state where battery cell 1 is thermally runaway and heated to a high temperature. Heat insulating base material member 4 can be composed of an insulating base material having innumerable voids and an insulating gel filled in the voids of the insulating base material. In optimum heat insulating base material member 4, a fiber assembly base material in which flame-retardant fibers are three-dimensionally assembled in a non-directional manner and innumerable voids are provided between the fibers is provided, and silica aerogel is filled in the voids of this fiber assembly base material. Silica aerogel is 90-98% air and has very good thermal conductivity of 0.017 W/(m·K), and its melting point is as high as 1200° C. Accordingly, even if battery cell 1 heats up to a high temperature due to the thermal runaway, conduction of heat energy can be stably blocked, and induction of the thermal runaway can be blocked. In particular, since silica aerogel is thermally insulated by fine hollow silica, most of convection, conduction, and radiation are blocked, and an extremely excellent heat insulating property is realized. Further, heat insulating base material member 4 in which the voids of the three-dimensionally assembled flame-retardant fibers are filled with silica aerogel has flexibility of being deformed by being pressed by expanding battery cell 1, and realizes excellent characteristics that can absorb the expansion while thermally insulating battery cell 1.

However, as heat insulating base material member 4, it is also possible to use a base material in which the voids of the fiber assembly base material are filled with another insulating gel such as alumina aerogel instead of silica aerogel. Furthermore, as heat insulating base material member 4, instead of the fiber assembly base material in which fibers are three-dimensionally assembled, it is also possible to use a base material in which a flexible foam having innumerable voids and open cells is used as the insulating base material and the voids of this insulating base material is filled with an insulating gel such as silica aerogel.

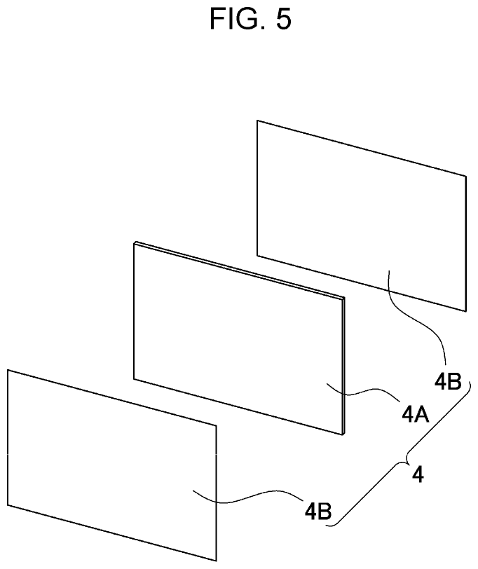

Heat insulating base material member 4 of FIG. 5 is a laminated base material in which protective sheets 4B are laminated and adhered on both sides of base material body 4A in which voids of an insulating base material are filled with an insulating gel. Protective sheet 4B is a woven fabric or a non-woven fabric. Heat insulating base material member 4 has a feature that the insulating gel can be prevented from leaking by protective sheets 4B adhered to both the sides. Further, high-performance base material body 4A in which the voids of the fiber assembly base material are filled with silica aerogel is a substance having poor mechanical strength and large brittleness, so it is difficult to regulate displacement of battery cell 1. This adverse effect can be prevented by adhering protective sheet 4B to both the sides. When heat insulating base material member 4 having low rigidity and weak shape retention of retaining flatness is used by being sandwiched between battery cells 1, heat insulating base material member 4 may be displaced or wrinkled, thereby causing a problem of marked deterioration in workability. This heat insulating base material member 4 can solve the problem by using protective sheet 4B laminated and adhered to a surface of base material body 4A as a shape-retaining sheet having higher rigidity and shape retention than heat insulating base material member 4. This shape-retaining sheet effectively prevents detachment of silica aerogel from the insulating base material. Further, since heat insulating base material member 4 is a laminated base material obtained by laminating the shape-retaining sheets having the higher rigidity and shape retention than base material body 4A, the rigidity can be enhanced without impairing the thermal insulation performance of the laminated base material. Therefore, the workability can be further improved.

For example, a plastic sheet is used as the shape-retaining sheet. Since shape retention of the plastic sheet can be adjusted by its thickness, for example, a hard plastic sheet having a thickness of 0.1 mm is used as the shape-retaining sheet. Heat insulating base material member 4 can have higher shape retention by adhering the shape retention sheets to both the sides of base material body 4A. However, the shape-retaining sheet can be adhered only to one side of base material body 4A.

Further, a surface of heat insulating base material member 4 is subjected to a water repellent treatment to reduce hygroscopicity, and thus it is possible to prevent an adverse effect such as an electric leak in which condensed water adheres to the surface. In addition, heat insulating base material member 4 has a feature that the heat insulating property can be further improved by laminating a plurality of base material bodies 4A and increasing thickness. The plurality of base material bodies 4A can be adhered to each other via an adhesive or a pressure sensitive adhesive, or can be adhered by partially melting the fibers of the fiber assembly base material.

As described above, separator 2 including outer peripheral frame 3 and heat insulating base material member 4 is disposed between adjacent battery cells 1 with heat insulating base material member 4 being disposed in opening 3X of outer peripheral frame 3. In separator 2 shown in FIG. 4, heat insulating base material member 4 can be disposed inside opening 3X by making an outer shape of heat insulating base material member 4 substantially equal to or slightly smaller than an inner shape of opening 3X of outer peripheral frame 3. Furthermore, in separator 2 shown in FIG. 4, in order to fix heat insulating base material member 4 to opening 3X of outer peripheral frame 3, fixing rib 3a protruding inward of opening 3X is integrally formed along a surface of one side of outer peripheral frame 3. This outer peripheral frame 3 fixes heat insulating base material member 4 at a fixed position by adhering outer peripheral edges of heat insulating base material member 4 disposed in opening 3X to a surface of fixing rib 3a. Fixing rib 3a is thinly formed with respect to thickness (t) of outer peripheral frame 3, and both sides of heat insulating base material member 4 disposed in opening 3X can come into contact with stacking surfaces 1A of battery cells 1 stacked on both sides of separator 2.

This separator 2 specifies an interval between adjacent battery cells 1 via outer peripheral frame 3 having heat insulating base material member 4 fixed to opening 3X, and both the sides of heat insulating base material member 4 disposed in opening 3X of outer peripheral frame 3 are disposed close to stacking surfaces 1A of facing battery cells 1, that is, disposed without a gap. Further, separator 2 thermally insulates adjacent battery cells 1 by heat insulating base material member 4 while absorbing swelling of stacking surface 1A of expanding battery cell 1 by deformed heat insulating base material member 4.

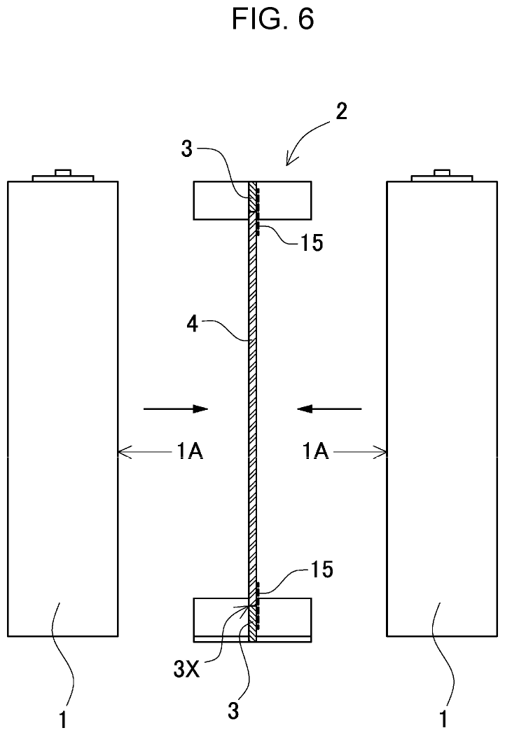

Furthermore, in separator 2, as shown in FIG. 6, heat insulating base material member 4 disposed in opening 3X of outer peripheral frame 3 can be fixed with adhesive tape 15. This separator 2 fixes heat insulating base material member 4 inside outer peripheral frame 3 by adhering adhesive tape 15 across the outer peripheral edges of heat insulating base material member 4 disposed inside opening 3X and the surface of outer peripheral frame 3. Heat insulating base material member 4 can fix at least facing peripheral edges to the outer peripheral frame via adhesive tape 15. However, heat insulating base material member 4 can also fix four sides of the outer peripheral edges to outer peripheral frame 3 via adhesive tape 15.

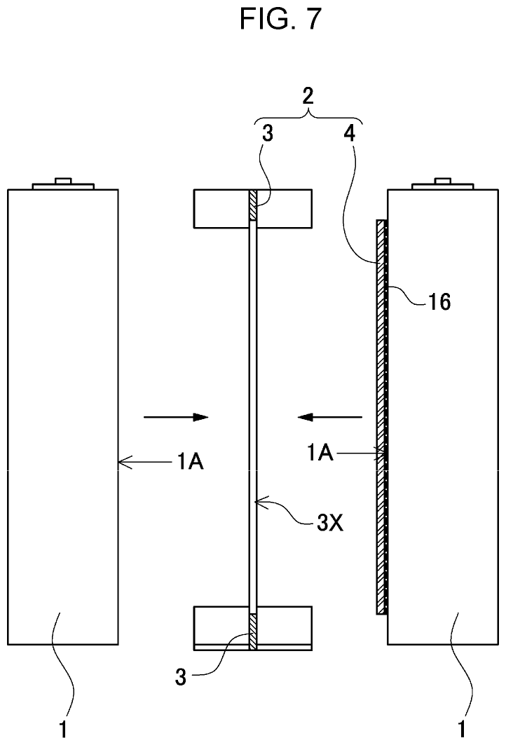

In separator 2 described above, heat insulating base material member 4 is disposed at the fixed position of outer peripheral frame 3 by fixing heat insulating base material member 4 to outer peripheral frame 3. However, heat insulating base material member 4 can also be fixed to stacking surface 1A of battery cell 1 without being fixed to outer peripheral frame 3. As shown in FIG. 7, in this structure, heat insulating base material member 4 is disposed in opening 3X of outer peripheral frame 3 by adhering heat insulating base material member 4 to a fixed position in a center of stacking surface 1A of battery cell 1 and then stacking battery cell 1 on outer peripheral frame 3. As described above, since heat insulating base material member 4 is attached to battery cell 1 and then assembled, when the plurality of battery cells 1 is assembled to form battery block 10, the structure in which heat insulating base material member 4 is adhered to stacking surface 1A of battery cell 1 can prevent heat insulating base material member 4 from being displaced or wrinkled with respect to battery cell 1. Heat insulating base material member 4 shown in the drawing is attached to stacking surface 1A of battery cell 1 via double-sided adhesive tape 16, but heat insulating base material member 4 can also be fixed to stacking surface 1A of battery cell 1 via an adhesive.

### (Battery Stack 9)

Battery stack 9 has the plurality of battery cells 1 and separators 2 stacked alternately. This battery stack 9 is stacked with separator 2 interposed between battery cells 1 adjacent to each other, and specifies an interval between adjacent battery cells 1 by separator 2. The plurality of battery cells 1 stacked to form battery stack 9 is connected to each other in series and/or in parallel by connecting positive and negative electrode terminals 1b. In battery stack 9, positive and negative electrode terminals 1b of adjacent battery cells 1 are connected to each other in series and/or in parallel via a bus bar (not shown).

In battery block 10 shown in FIG. 3, 18 battery cells 1 are connected so that three battery cells 1 are connected in parallel and six battery cells 1 are connected in series. Battery block 10 in which adjacent battery cells 1 are connected in parallel and battery cells 1 connected in parallel are connected in series to each other can increase output voltage and increase an output while increasing output current. However, the present invention does not specify a number of battery cells 1 forming the battery stack and a connection state of battery cells 1. In the battery block, a number of battery cells 1 connected in parallel and in series can be variously changed, or all battery cells 1 can be connected in series or connected in parallel.

Furthermore, in the power supply device shown in the drawing, end plates 7 constituting fixing member 6 are disposed outside battery cells 1 disposed at both ends of battery stack 9 via end separators 14. In this structure, while end plates 7 are made of metal, battery cells 1 whose exterior cans 1x are made of metal can be stacked by insulating with end separators 14 having insulating properties. With this configuration, it is possible to reliably insulate the plurality of stacked battery cells 1 and to provide a more reliable power supply device.

### (Fixing Member 6)

Battery stack 9 formed by stacking the plurality of battery cells 1 and separators 2 is fastened in the stacking direction via fixing member 6. Fixing member 6 shown in FIGS. 1 and 2 includes end plates 7 disposed at both ends of battery stack 9 and binding bars 8 fixed to end plates 7 and fastening battery stack 9 in the stacking direction via end plates 7. However, the fixing member is not necessarily specified to end plate 7 and bind bar 8. As the fixing member, any other structure capable of fastening the battery stack in the stacking direction can be used.

### (End Plate 7)

As shown in FIG. 2, end plates 7 are disposed at both ends of battery block 10 and outside end separators 14. End plate 7 is a quadrangle having substantially the same shape and size as the outer shape of battery cell 1, and holds stacked battery stack 9 from both end surfaces. End plate 7 is entirely made of metal. Metal end plate 7 can realize excellent strength and durability. A pair of end plates 7 disposed at both ends of battery block 10 are fastened via a pair of bind bars 8 disposed on both side surfaces of battery stack 9, as shown in FIGS. 1 and 2.

### (Bind Bar 8)

Bind bars 8 are fixed to end plates 7 disposed on both end surfaces of battery stack 9, and fasten battery stack 9 in the stacking direction via end plates 7. Bind bar 8 is a metal plate having a predetermined width and a predetermined thickness along the surface of battery stack 9. For this bind bar 8, a metal plate such as iron, preferably a steel plate, can be used. As shown in FIGS. 1 and 2, bind bar 8 made of a metal plate is disposed along the side surface of battery stack 9, and both ends are fixed to the pair of end plates 7 to fasten battery stack 9 in the stacking direction.

The above power supply device is most suitable for a power supply device for a vehicle that supplies electric power to a motor that causes an electric vehicle to travel. As the electric vehicle equipped with the power supply device, there are an electric vehicle such as a hybrid car or a plug-in hybrid car that runs with both an engine and a motor, and an electric vehicle such as an electric car that runs only with a motor. The power supply device is used as a power supply for these electric vehicles.

### (Power Supply Device for Hybrid Car)

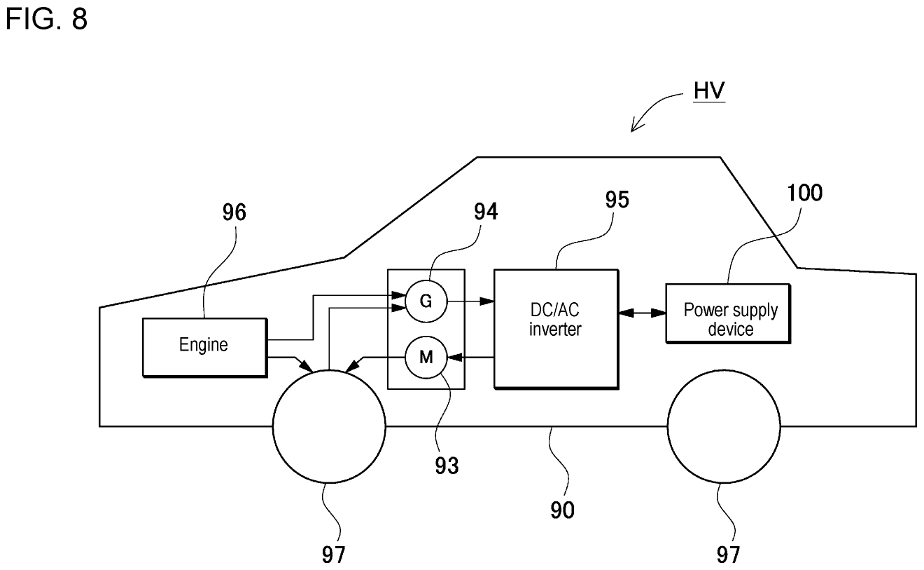

FIG. 8 shows an example in which the power supply device is mounted on a hybrid car that runs with both an engine and a motor. Vehicle HV equipped with the power supply device shown in this drawing includes vehicle body 90, engine 96 and traveling motor 93 that cause vehicle body 90 to travel, power supply device 100 that supplies electric power to motor 93, generator 94 that charges batteries of power supply device 100, and wheels 97 driven by motor 93 and engine 96 to cause vehicle body 90 to travel. Power supply device 100 is connected to motor 93 and generator 94 via DC/AC inverter 95. Vehicle HV runs with both motor 93 and engine 96 while charging and discharging the batteries of power supply device 100. Motor 93 causes the vehicle to travel by being driven in a region where engine efficiency is low, for example, during acceleration or low speed traveling. Motor 93 is driven by the electric power supplied from power supply device 100. Generator 94 is driven by engine 96 or by regenerative braking during braking of the vehicle to charge the batteries of power supply device 100.

### (Power Supply Device for Electric Car)

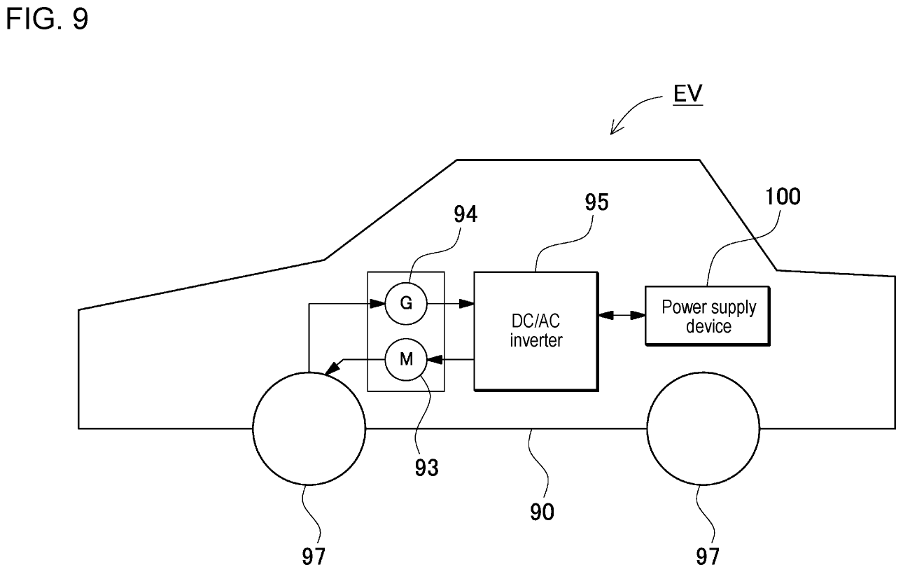

Further, FIG. 9 shows an example in which the power supply device is mounted on an electric car that runs only with a motor. Vehicle EV equipped with the power supply device shown in this drawing includes vehicle body 90, traveling motor 93 that causes vehicle body 90 to travel, power supply device 100 that supplies electric power to this motor 93, generator 94 that charges batteries of this power supply device 100, and wheels 97 driven by motor 93 to cause vehicle body 90 to travel. Motor 93 is driven by the electric power supplied from power supply device 100. Generator 94 is driven by energy when regenerative braking is applied to vehicle EV to charge the batteries of power supply device 100.

### (Power Supply Device for Power Storage)

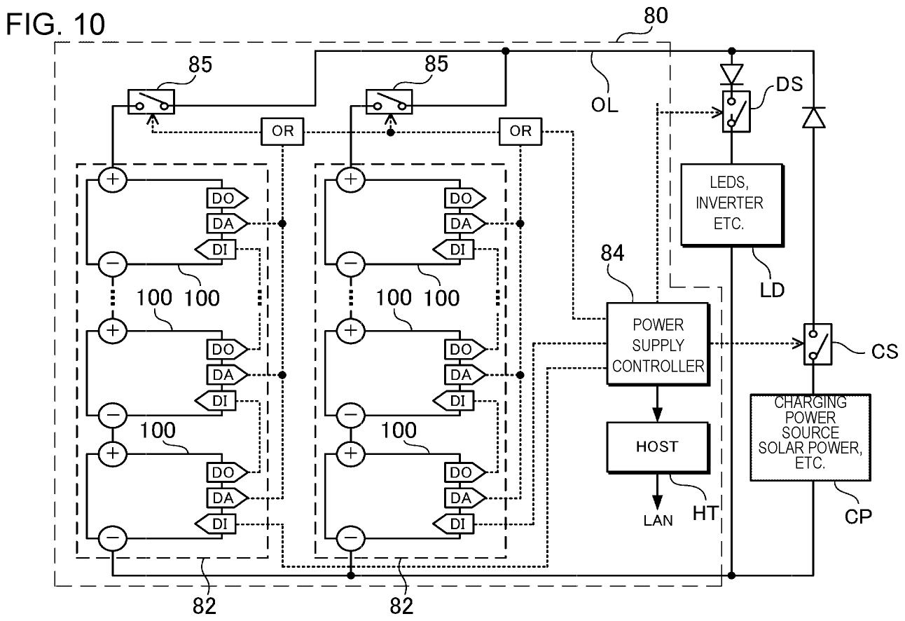

Furthermore, the present invention does not specify an application of the power supply device to a power supply device mounted on an electric vehicle. For example, the power supply device can be used as a power supply device for a power storage apparatus that stores natural energy such as solar power generation and wind power generation, or can be used for all applications that store large amounts of power, such as a power supply device for a power storage apparatus that stores midnight power. For example, as a power supply for a household and a factory, the power supply device can also be used as a power supply system that charges with sunlight or midnight power and discharges when necessary, a power supply for a street light that charges sunlight during a day and discharges at night, or a backup power supply for a traffic signal that is driven during power failure. Such an example is shown in FIG. 10. Note that in the usage example as the power storage apparatus shown in FIG. 10, large-capacity, high-output power storage apparatus 80 in which a large number of the power supply devices described above are connected in series or in parallel to obtain desired power and to which a necessary control circuit is added will be described as a constructed example.

In power storage apparatus 80 shown in FIG. 10, power supply unit 82 is configured by connecting a plurality of power supply devices 100 in a unit. In each power supply device 100, a plurality of battery cells is connected in series and/or in parallel. Each power supply device 100 is controlled by power supply controller 84. Power storage apparatus 80 drives load LD after charging power supply unit 82 with charging power supply CP. Therefore, power storage apparatus 80 has a charge mode and a discharge mode. Load LD and charging power supply CP are connected to power storage apparatus 80 via discharge switch DS and charge switch CS, respectively. ON/OFF of discharge switch DS and charge switch CS is switched by power supply controller 84 of power storage apparatus 80. In the charge mode, power supply controller 84 turns on charge switch CS and turns off discharge switch DS to permit charge from charging power supply CP to power storage apparatus 80. In addition, when the charge is completed and the power storage apparatus is fully charged, or when a capacity of a predetermined value or more is charged, power supply controller 84 turns off charge switch CS and turns on discharge switch DS in response to a request from load LD. The mode is switched to the discharge mode to permit discharge from power storage apparatus 80 to load LD. Further, if necessary, charge switch CS and discharge switch DS can be turned on to supply power to load LD and charge power storage apparatus 80 at the same time.

Load LD driven by power storage apparatus 80 is connected to power storage apparatus 80 via discharge switch DS. In the discharge mode of power storage apparatus 80, power supply controller 84 turns on discharge switch DS to connect to load LD and drives load LD with the power from power storage apparatus 80. As discharge switch DS, a switching element such as a field effect transistor (FET) can be used. ON/OFF of discharge switch DS is controlled by power supply controller 84 of power storage apparatus 80. Power supply controller 84 also includes a communication interface for communicating with external devices. In the example of FIG. 9, host device HT is connected according to an existing communication protocol such as a universal asynchronous receiver transmitter (UART) or a recommended standard (RS)-232C. Further, if necessary, a user interface for a user to operate a power supply system can be provided.

Each power supply device 100 includes a signal terminal and a power supply terminal. The signal terminal includes input/output terminal DI, abnormality output terminal DA, and connection terminal DO. Input/output terminal DI is a terminal for inputting/outputting a signal from other power supply device 100 or power supply controller 84, and connection terminal DO is a terminal for inputting/outputting a signal to/from other power supply device 100. Further, abnormality output terminal DA is a terminal for outputting an abnormality of power supply device 100 to an outside. Furthermore, the power supply terminal is a terminal for connecting power supply devices 100 in series and in parallel to each other. Further, power supply units 82 are connected to output line OL via parallel connection switches 85 and are connected in parallel to each other.

### INDUSTRIAL APPLICABILITY

A power supply device according to the present invention can be suitably used as a power supply device for a plug-in type hybrid electric car or a hybrid electric car which can be switched between an EV driving mode and an HEV driving mode, and for an electric car, etc. Further, it can also be appropriately used for applications, such as a backup power supply that can be installed in a computer server rack, a backup power supply for a mobile phone wireless base station, a power storage power supply for a household and a factory, a street light power supply, a power storage apparatus combined with a solar battery, a backup power supply for a traffic light.

### REFERENCE MARKS IN THE DRAWINGS

100 power supply device
1 battery cell
1A stacking surface
1B side surface
1C top surface
1D bottom surface
1a sealing plate
1b electrode terminal
1c safety valve
1x exterior can
2 separator
3 outer peripheral frame
3X opening
3a fixing rib
4 heat insulating base material member
4A base material body
4B protective sheet
6 fixing member
7 end plate
8 bind bar
9 battery stack
10 battery block
14 end separator
15 adhesive tape
16 double-sided adhesive tape
80 power storage apparatus
82 power supply unit
84 power supply controller
85 parallel connection switch
90 vehicle body
93 motor
94 generator
95 DC/AC inverter
96 engine
97 wheel
HV vehicle
EV vehicle
LD load
CP charging power supply
DS discharge switch
CS charge switch
OL output line
HT host device
DI input/output terminal
DA abnormality output terminal
DO connection terminal

1. A power supply device comprising:
a battery stack formed by stacking a plurality of battery cells;
a separator disposed between the plurality of battery cells; and
a fixing member that fastens the battery stack in a stacking direction,
wherein the separator includes an outer peripheral frame and a heat insulating base material member provided in an opening of the outer peripheral frame,
the outer peripheral frame is disposed on an outer periphery of a stacking surface of each of the plurality of battery cells and has the opening inside,
the heat insulating base material member has flexibility of being deformed by being pressed by expanding of the stacking surface of each of the plurality of battery cells,
the outer peripheral frame has higher rigidity than that of the heat insulating base material member,
the outer peripheral frame specifies an interval between adjacently stacked ones of the plurality of battery cells, and
the heat insulating base material member having flexibility absorbs expansion of the stacking surface of each of the plurality of battery cells.

2. The power supply device according to claim 1, wherein the outer peripheral frame is made of plastic.

3. The power supply device according to claim 1, wherein the heat insulating base material member includes an insulating base material having innumerable voids and an insulating gel filled in the voids of the insulating base material.

4. The power supply device according to claim 3, wherein the insulating base material is a fiber assembly base material formed by three-dimensionally assembling flame-retardant fibers in a non-directional manner and providing innumerable gaps between the flame-retardant fibers.

5. The power supply device according to claim 3, wherein the insulating base material is a foam having open cells.

6. The power supply device according to claim 3, wherein the insulating gel is aerogel.

7. The power supply device according to claim 6, wherein the aerogel is silica aerogel.

8. The power supply device according to claim 1, wherein the outer peripheral frame has a frame shape along four sides of the stacking surface of each of the plurality of battery cells.

9. An electric vehicle provided with the power supply device according to claim 1, the electric vehicle comprising:
the power supply device; a traveling motor supplied with electric power from the power supply device; a vehicle body formed by mounting the power supply device and the motor; and wheels driven by the motor to cause the vehicle body to travel.

10. A power storage apparatus provided with the power supply device according to claim 1, the power storage apparatus comprising:
the power supply device; and a power supply controller that controls charge and discharge to and from the power supply device,
wherein the power supply controller charges the plurality of battery cells with electric power from an outside and controls the plurality of battery cells to be charged.
